(19) United States
(12) Patent Application Publication
(10) Pub. No.: US 2003/0025320 A1
(43) Pub. Date: Feb. 6, 2003

(54) Method and apparatus for making medicine container

(76) Inventor: Catherine Shoemaker, Beaumont, TX (US)

Correspondence Address: CONLEY ROSE & TAYON, P.C., P. O. BOX 3267, HOUSTON, TX, 77253-3267, US

(21) Appl. No.: 09/853,568

(22) Filed: Aug. 3, 2001

(51) Int. Cl. B42D 15/00

(52) U.S. Cl. 283/81

(57) ABSTRACT

A medicine receptacle label apparatus and method is proposed. The labeling system includes the placement of an iconic label upon the exterior of a medicine receptacle to graphically assist the patient in taking the proper medication. The iconic labels include descriptive icons that graphically depict either the symptoms or desired result for which the medicine contained therein is to be taken, among others. The present invention will assist the elderly and vision impaired the most, enabling them to select and consume their medications properly.

### BACKGROUND OF THE INVENTION

1. Field of the Invention

The present invention generally relates to a marking system and apparatus for containers using icons to identify and represent the desired use for the contents. More specifically, the present invention relates to a graphical marking apparatus and method for medicine receptacles whereby iconic decals are applied to the medicine receptacles to assist in identifying the contents or whereby graphical representations are created on or in the perimeter of or covering to the receptacle.

2. Description of the Related Art

Many different containers are known to be in existence for the storage and transportation of medicines, whether liquid, powder, or solid form. A popular example of a medicine container, as widely deployed throughout the pharmaceutical industry predominately for use with solid medication (i.e. tablets, capsules, and pills), generally takes the shape of a cylinder with one open end and a circular shaped cap removably engaged thereupon. Caps for medicine bottles of this type can be fastened in a variety of ways, and be of several types of manufacture.

One of the most popular and widely used types of medicine bottles include “childproof” style caps. Such caps are designed to be removed only by the dexterous hands of an adult, often requiring compound actions to gain access to the bottle's contents. It is believed that young children would be unable to open such bottles, thus protecting them from accidentally consuming the potentially harmful contents. Unfortunately, the amount of skill required to open such a container can also prove to be difficult for the intended recipient of the medicine. The relatively

One embodiment of the present helps alleviate these concerns by placing graphical icons on the outside of the medicine containers, so that when the patients look at these containers he or she will know why the medication has been prescribed. For instance, a picture of a knee with an arrow pointing to the knee lets the patient know the medication is for the pain in their knee. They very same pain medication might be given to another patient for pain in their hands. In such case, the icon would comprise a picture of an elbow with an arrow pointing to the elbow. Again, looking down at the pictures will greatly help those patients to know what it is for, without having to remember long, technical names. These icon labels can be made for any health problem concerning the human anatomy. These icons will not only help the patient, but also they will help family and other caregivers know why the medicine has been prescribed. One option is to sell these labels over the counter, preferably in a pharmacy. A display will let a patient read about the icons, thus being able to ask the pharmacist for more information. To date, no reliable system for marking medicine receptacles to make them easily identifiable by the elderly and vision impaired exists.

### BRIEF SUMMARY OF THE INVENTION

The deficiencies of the prior art may be overcome through the use of a medicine receptacle labeling system and method that includes the placement of an iconic label upon the receptacle exterior. Such an iconic label would graphically assist the patient in taking the proper medication by including a descriptive icon to graphically depict either the symptoms and/or desired result for which the medicine contained therein is to be taken. Such an iconic labeling system would be most beneficial to the elderly and vision impaired, enabling them to select and consume their medications properly with a lessened risk of ingesting improper medicine.

### BRIEF DESCRIPTION OF THE DRAWINGS

For a detailed description of a preferred embodiment of the invention, reference will now be made to the accompanying drawings wherein:

FIG. 1 is a perspective view of a traditional medicine receptacle;

FIG. 2 is a perspective view of a medicine receptacle with an iconic label in accordance with a preferred embodiment of the present invention; and

FIG. 3 is a top view of the cap of FIG. 2 showing a sample iconic label in accordance with a preferred embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Referring initially to FIG. 1, a traditional medicine bottle 10 is shown. Medicine bottle 10 includes a primary housing 12, a cap 14, and a label 16. Housing 12 is preferably constructed in the shape of a cylinder that is enclosed at one end 18 and left open another end 20, but may be a housing of any shape or size capable of retaining doses of medicine. Cap 14 is preferably placed atop open end 20 of housing 12 and is preferably removably secured thereupon either threadably or through a “snapping” engagement. Cap 14 may be of the “childproof” configuration, whereby a compound action is required to remove cap 14 from housing 12. Label 16 is shown affixed upon the outer circumference of housing 12. Label 16 typically includes the prescribing physician's name, the pharmacy contact information, the name (often both generic and brand names) of the medication inside, the amount of medication inside, the proper dosage amounts and intervals, and refill allowances, if any.

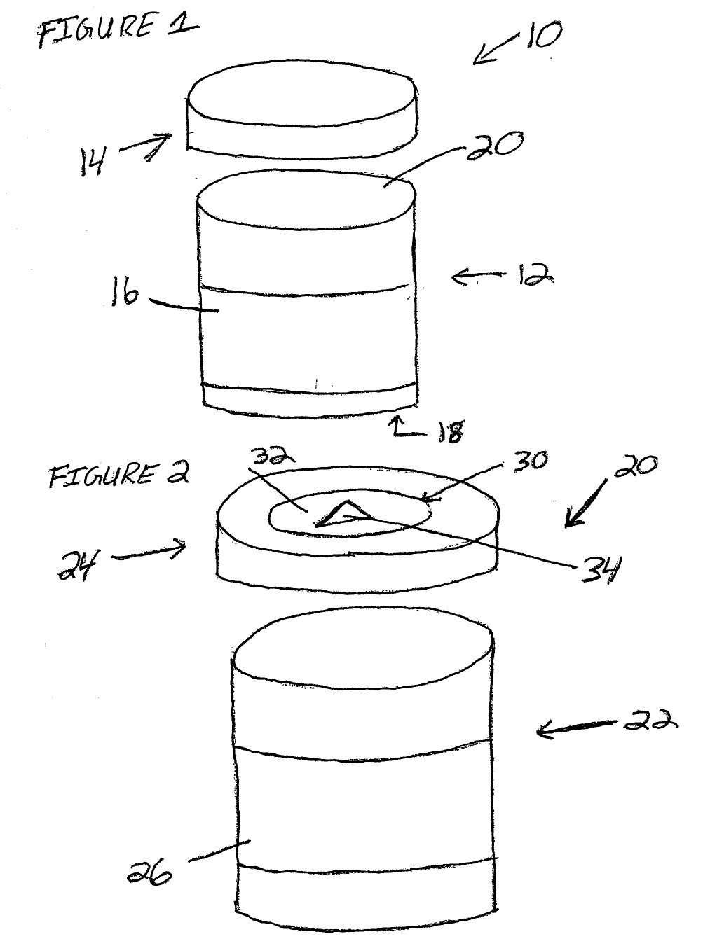

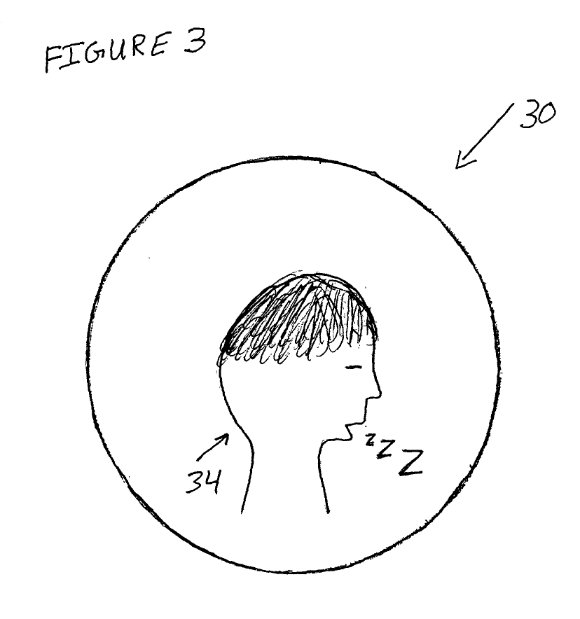

Referring now to FIG. 2, a medicine receptacle 20 in accordance with a preferred embodiment of the present invention is shown. Receptacle 20 includes a housing 22, a cap 24 and a primary label 26 in much the same manner as bottle 10 of FIG. 1. Receptacle 20 further includes an iconic label 30, affixable anywhere about the outside of receptacle 20, but preferably located atop cap 24, as shown, because visibility is maximized. One embodiment of iconic label 30 includes a printable media 32 upon which a graphical icon 34 is printed or otherwise represented. Iconic label 30 preferably has self-adhesive backing to attach upon cap 24. An alternative embodiment of iconic label 30 would have graphical icon 34 printed, embossed, stamped, pressed, or otherwise imprinted in or on cap 24.

Graphical icon 34 upon iconic label 30 is selected to be indicative of either the medicine contained within receptacle 20 or its intended use. Icon 34 may be selected from a wide assortment of graphical depictions that indicate the contents of receptacle 20 and are preferably selected as “standard” symbols that will be understood by the widest number of patients with little or no explanation.

As an example, the icon 34 of label 30 of FIG. 3 would be best used to indicate that a sleep medication is contained within receptacle 20. Further, iconic labels 30 need not be pictorial, but rather may be colored or other symbols such as a blue circle or a red square. While these colored symbols may not immediately be associated with a particular medicine or use, the patient will associate the colored symbols with certain medicine or uses much more quickly than a purely textual label.

When symptoms, or a dosage timetable, indicate that a medication is to be ingested, the patient will be able to identify the proper medicine from a plurality of receptacles 20 by scanning the various iconic labels 30. Although iconic labels 30 may be applied at any time, it is preferred that they be applied to their respective receptacles by the pharmacist at the time the prescription is filled. Alternatively, the pharmacist may include a sheet of assorted self-adhesive iconic labels 30 with each prescription, or the labels 30 may be sold separately over the counter at any number of stores, thus enabling the patient to label their medications as they see fit. This is beneficial because often medications may be prescribed for multiple purposes. A particular medication may be prescribed to one patient to reduce blood pressure, and prescribed to another as a pain killer. As a further alternative, iconic labels 30 may be applied by hospitals (including emergency rooms), doctor's offices, clinics, or other facilities that provide medication.

Even with the varied uses of many drugs, it may still be preferable for the pharmacist to apply iconic labels 30 to receptacles 20 because they are more knowledgeable in the dosages and identities of various medications and are much less likely to improperly label a receptacle 20. For drugs with more than one common use, the pharmacist would be able to interpret the prescribing physician's dosage and symptom notes on the original prescription to help them determine which iconic label 30 to apply to receptacle 20. small size of the medicine bottle coupled with the combination of steps required to open the childproof container can prohibit many elderly, vision impaired, or even arthritic patients from receiving their proper dosages without assistance. To accommodate those patients that have difficulty or are unable to open such devices, pharmacies often issue medication in easy to open non-childproof containers. Although these containers are less difficult for the patient to open, they are also easier for others to open so extra precautions must be taken to keep them out of the hands of small children.

Another issue to the elderly and vision impaired of great concern is the issue of medicine container labeling. In the case of a medicine or pill bottle, typically a label is affixed to the outer, cylindrical portion of the bottle to thoroughly describe the contents, dosage, and any special precautions for the content's use. This label usually includes pertinent information such as the name of the medicine, the prescribing doctor's name and phone number, the dispensing pharmacy's phone number, the prescribed dosage amount and interval, and special restrictions. For example, U.S. Pat. No. 5,752,723 is directed to a pharmacy label containing such information, hereby incorporated herein by reference. Special restrictions that may be included upon the label may include suggestions to take the medication with food, or a warning not to operate heavy machinery because of drowsiness the medicine may induce.

Unfortunately, the label is often too small or too cryptic for elderly or vision impaired patients to comprehend properly. Text located on the label is often small and usually includes medical terms or scientific names of medication that the average patient does not easily understand. The matter of simply enlarging the text of the label is not always a possible solution, as space on the medicine bottle is finite. One solution to this problem has been to magnify the labels using an external source, such as described in U.S. Pat. No. 5,193,032, hereby incorporated herein by reference.

Because a majority of the information on the label is required by law, it is unlikely that any of the information may be removed to allow for the enlargement of any remaining text or labels. Elderly and vision impaired patients need a system and method of identifying their medications accurately, easily, and quickly. A system capable of accomplishing these tasks in an improved amount of time and with a high degree of certainty is desirable.

In addition to labels disposed on the outer portion of the medicine source, containers, paper labels are usually attached to the bag containing the prescriptions. These labels inform the patient what the prescribed medicine is, what it is for, and what possible side effects may occur. Within days, if not minutes, however, these labels get separated from the medicine containers. At that point, the patient must rely on the small label disposed on the container or must rely on his or her memory to know what medicine is in the container. If someone has a lot of health problems and has to take a lot of medicines, it is very difficult to remember which medications are for the different ailments.

To add to the confusion, these medications have long technical names that are hard to read—much less pronounce. There are so many medicines that a lot of them sound alike. For example, brand names can be Atarax for itching, Ambien for sleep, or Prilosec for stomach problems. The generics for these medications sound complicated. For example, hydroxizine for itching, prmethazine for nausea, cimetidine for the stomach, phenazopyridine for the bladder, and chlordiazpx for the colon. The list is overwhelming for these technical medicines. If one has poor eye sight, cannot read, or is not good at remembering, it makes taking medication difficult and dangerous. There is a chance of taking the wrong medication.

What is claimed:

1. An apparatus for marking a medicine receptacle, comprising:
a housing having an open end and an external surface, said housing configured to retain dosages of the medicine;
a cover to be removably secured to said open end, said cover separating the medicine held within from an outside environment; and
an iconic label, said label being disposed on said cover to graphically describe the medicine held therein.

2. The apparatus of claim 1 wherein said iconic label is disposed on said external surface.

3 The apparatus of claim 1 wherein said iconic label further comprises a representation that communicates to a patient application for which the medicine is to be used by the patient.

4. The apparatus of claim 1 wherein said iconic label further comprises a representation that communicates why the medicine is prescribed.

5. The apparatus of claim 1 wherein said iconic label further comprises at least one drawing to depict results of the consumption of the medicine by a patient.

6. The apparatus of claim 1 wherein said iconic label further comprises at least one drawing to depict symptoms which the consumption of the medicine by a patient is expected to alleviate.

7. A method for marking a medicine receptacle comprising:
affixing a label about the exterior of a receptacle; and
providing on the label iconic representation communicating why the medicine has been prescribed.

8. The method of claim 7 wherein said step of providing further comprises communicating a desired result of a patient consuming the medication.

9. The method of claim 7 wherein said step of providing further comprises communicating symptoms which consumption of the medicine by a patient is expected to alleviate.

10. The method of claim 7 wherein the receptacle has a cover and said step of affixing further comprises affixing the label to the cover.

11. An icon for marking a medicine receptacle, comprising:
a label having first and second sides;
said first side having an adhering surface and said second side having an external printable media;
a graphic communicating why the medicine has been prescribed, said graphic affixed to said external printable media.

12. The container of claim 1 wherein said graphical is a colored symbol.
